(19) United States
(12) Patent Application Publication
(10) Pub. No.: US 2004/0110657 A1
(43) Pub. Date: Jun. 10, 2004

(54) Treatment of surfaces for temporarily improving their removal behavior

(76) Inventor: Werner Strothoff, Sassenberg Fuchtorf (DE)

Correspondence Address: Andrew D Sorensen, Ecolab Inc, Research & Development Center, 840 Sibley Memorial Highway, Mendota Heights, MN, 55118, US

(21) Appl. No.: 10/416,480

(22) PCT Filed: Oct. 31, 2001
(86) PCT No.: PCT/EP01/12635

(30) Foreign Application Priority Data
Nov. 29, 2000 (DE) 10055555.1

(51) Int. Cl. C11D 17/00

(52) U.S. Cl. 510/426

(57) ABSTRACT

Stable, aqueous preparations are described which contain selected substances in order, on surface treatment, to condition surfaces in such a manner that said surfaces may subsequently more easily be cleaned using conventional agents than identical surfaces which have not been treated with the claimed preparations. Corresponding cleaning processes and a cleaning preparation are also presented.

This invention relates to the use of stable, aqueous preparations which contain selected substances for treating surfaces in order to obtain surfaces which may subsequently more easily be cleaned using conventional agents than identical surfaces which have not been treated with the claimed preparations and to a cleaning process and cleaning preparation.

When cleaning surfaces, in particular surfaces which are contaminated with tenacious soiling, considerable effort is frequently required in order as far as possible to remove all the residues from the surfaces. The cleaning agent manufacturing industry offers chemical agents which, by virtue of the efficacy thereof, are very largely suitable for removing most contaminants. Manufacturers of cleaning machines or equipment contribute towards removing contaminants from the most varied surfaces by means of skilful equipment design and tailored processes.

Although this interplay of cleaning agents, machinery, temperature and time operates without any problem in many cases, there is a requirement, on economic and environmental grounds, to perform cleaning operations with a smaller quantity of and/or more compatible cleaning agents and/or in a shorter time and/or at lower temperature and/or with less mechanical and/or manual effort.

In practical application, it is conventional that when one process parameter, such as time, chemistry, temperature or machinery, goes down, another one goes up. This has the disadvantage that while an improvement may indeed be achieved in one criterion, for example in consumption of chemicals, an impairment must consequently be accepted in other criteria, such as for example temperature or elevated energy consumption or lengthening of the entire process.

Providing surfaces with permanently adhering compounds would in fact bring about a reduction in cleaning effort. This type of soil release finish is used, for example, in finishing textiles with substances which prevent the deposition of soil or facilitate the removability thereof by washing. Preparations for such soil release applications contain, for example, perfluorinated fatty acids, also in the form of the aluminium or zirconium salts thereof, organic silicates, silicones, polyacrylic acid esters with a perfluorinated alcohol component or polymerisable compounds coupled with a perfluorinated acyl or sulfonyl residue. Antistatic agents may also be present. This type of soil-repellant finish is often classed as an easy care finish.

It has, however, been found in practice that the compounds used for this permanent finish which are based on fluoroaliphatic silyl ethers or other systems mainly based on silicon compounds or fluorine compounds generally entail various disadvantages. For example, over the course of several cleaning operations these permanent finishes, contrary to their intended purpose, are removed from the surface, resulting in a loss of the soil-repellant action. As a consequence, for example in the case of machine washing, these strongly adhering compounds pass into the lines and other peripheral equipment, so generating disadvantages, such as the formation of deposits and precipitates and even large agglomerations of the coating in the cleaning apparatus. This results in disruption to the cleaning operation which may go as far as causing machine breakdowns. Moreover, the silicon or fluorine compounds conventionally used for the permanent finish are usually largely non-degradable and are thus questionable on environmental grounds.

It was accordingly not the object of the present invention to provide a permanent surface finish with soil repellant compounds, but instead purposefully to seek out formulations for treating surfaces which may be applied during or after a cleaning operation and which modify the condition of the surface such that soiling or contamination is more readily removable from the surfaces treated in this manner using conventional agents than in the case of identically soiled or contaminated, but not pretreated surfaces, wherein the surfaces treated in this manner should lose the desired effect if the treatment is not repeated during or after the next cleaning operation. It was desired for the purposes of the present invention that the least possible foaming occurs during use, such that the additional use of specific defoamers may as far as possible be dispensed with.

The stated object is achieved by the present invention, namely the use of a stable aqueous preparation, which contains both a foaming surfactant and calcium in bound form, in undiluted or diluted form for treating surfaces, in order to obtain surfaces which may subsequently more easily be cleaned using conventional agents than identical surfaces which have not been treated with the claimed preparations. The preparation to be used according to the invention preferably contains, relative to the entire preparation,

a) between 0.2 and 40 wt. % of the foaming surfactant and

b) between 0.1 and 20 wt. % of a calcium compound, particularly preferably calcium chloride or calcium acetate.

Bound calcium should primarily be taken to mean calcium held in chemical substances by covalent, ionic or van der Waals bonds. For the purposes of the present invention, dissociable calcium is accordingly also deemed to be bound calcium.

The preparation to be used according to the invention particularly preferably contains as foaming surfactant one or more components selected from the group consisting of non-alkoxylated surfactants containing alkyl groups with a saturated or unsaturated, branched or linear alkyl group with 8 to 22 C atoms, wherein the preparation in particular contains as non-alkoxylated surfactant containing alkyl groups one or more components selected from the groups consisting of

a) alkyl sulfates with a saturated or unsaturated, branched or linear alkyl group with 8 to 22 C atoms, preferably with 10 to 16 C atoms, particularly preferably sodium lauryl sulfate,

b) alkyl glucosides with a saturated or unsaturated, branched or linear alkyl group with 8 to 22 C atoms, preferably with 10 to 16 C atoms, particularly preferably lauryl glucoside,

c) fatty acid ethanolamides with a saturated or unsaturated, branched or linear alkyl group with 8 to 22 C atoms, preferably with 10 to 16 C atoms, particularly preferably lauryl ethanolamide.

Conventional agents are taken for the purposes of the present invention to mean alkaline, neutral or acidic agents which, depending upon the surface and cleaning process, may be combined with various ingredients such as surfactants, enzymes, oxidising agents, complexing agents, chlorine derivatives, antimicrobial active substances, corrosion inhibitors, defoaming agents or other ingredients.

In the case that the preparations to be used according to the invention contain lauryl glucoside, these formulations are used such that the treated surface receives additional antimicrobial protection by virtue of the antimicrobial properties of lauryl glucoside.

It is furthermore preferred that the preparations to be used according to the invention additionally contain one or more further surfactants selected from the groups consisting of anionic, cationic, nonionic, amphoteric surfactants, phosphoric acid esters, alkylamine oxides and the salts thereof as well as silicone compounds, wherein it is particularly preferred that the preparations to be used according to the invention contain, as a further nonionic surfactant, an alkoxylated alkyl alcohol with 8 to 22 C atoms in the alkyl chain, particularly preferably from the group comprising mixed ethoxylates/propoxylates of branched or unbranched alkyl alcohols with 8 to 22 C atoms in the alkyl moiety and of end-terminated ethoxylates of branched or unbranched alkyl alcohols with 8 to 22 C atoms in the alkyl chain and very particularly preferably from the group comprising mixed ethoxylated and propoxylated alkyl alcohols with 12 to 22 C atoms in the alkyl moiety, butyl ethers of an ethoxylated alkyl alcohol with 12 to 22 C atoms in the alkyl moiety and methyl ethers of an ethoxylated alkyl alcohol with 12 to 22 C atoms in the alkyl moiety, wherein it is also preferred that the formulations to be used according to the invention also contain, as a further nonionic surfactant, at least one alkylpolyglucoside with 8 to 14 C atoms in the alkyl group and 1 to 5 glucose units and in one very particularly preferred embodiment the surfactants used in the formulations to be used according to the invention have antifoaming properties, wherein this embodiment is particularly preferred when, for example, dispensing with surfactants having defoaming properties would cause severe foaming and would obstruct the cleaning and rinsing operation in any way.

The preparations to be used according to the invention preferably additionally contain one or more antimicrobial components selected from the group consisting of alcohols, aldehydes, antimicrobial acids, carboxylic acid esters, acid amides, phenols, phenol derivatives, diphenyls, diphenylalkanes, urea derivatives, oxygen/nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophores, peroxides, wherein it is particularly preferred if the formulations contain, as antimicrobial components, one or more compounds selected from among ethanol, n-propanol, i-propanol, 1,3-butanediol, phenoxyethanol, 1,2-propylene glycol, glycerol, undecylenic acid, citric acid, 2-benzyl-4-chlorophenol, 2,2′-methylene-bis(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)-bis(1-octanamine) dihydrochloride, N,N′-bis(4-chlorophenyl)-3,12-diimino-2,4,11,13-tetraazatetradecanediimideamide, quaternary ammonium compounds of alkylamines, guanidines, amphoteric compounds.

In another preferred embodiment, the preparations to be used according to the invention additionally contain solubilising agents, such as for example cumene sulfonate, monohydric alcohols, such as isopropanol, butanol, ethanol as well as polyhydric alcohols such as glycols or glycerols and the ethers and esters thereof, wherein the term solubilising agent may also include surfactants, such as fatty amine ethoxylates and other substances having solubilising properties.

It is furthermore preferred that the preparations to be used according to the invention assume the form of a presentation selected from among a stable aqueous solution, gel, paste or shaped solid, wherein it is also preferred if the preparations to be used according to the invention are produced by dissolution in water from a non-aqueous presentation and a water-soluble shell, which is preferably based on polyvinyl alcohol, wherein the water-soluble shell very particularly preferably contains a proportion of the formulation constituents.

It is furthermore preferred, depending upon the type of soiling, and upon processing, machinery and other prerequisites, that the preparations to be used according to the invention are applied onto the surface in undiluted or diluted form, wherein it is particularly preferred that the surface to be treated is treated by dipping. It may be preferred from instance to instance that the preparations to be used according to the invention are applied onto the surfaces to be treated in undiluted or diluted form by auxiliary means, which may be selected from among paint brushes, sponges, rollers, cloths, rags, brushes, squeegees, rubber, mops, flat mop heads, sprayers.

It is furthermore preferred to dilute the preparations to be used according to the invention with water to concentrations of below 15000 ppm, particularly preferably to 15 to 10000 ppm and very particularly preferably to 50 to 1000 ppm and to apply them to the surfaces to be treated at this concentration. The contact time between the preparations to be used according to the invention and the surfaces to be treated is preferably at least the time which is required to wet the surface to be treated, wherein it is particularly preferred if the contact time is longer than 5 seconds and it is very particularly preferred if, after contact, rinsing with water is not performed. The treatment temperature is preferably 5 to 95° C. and is particularly preferably between 20 and 85° C.

The preparations to be used according to the invention are preferably used for the treatment of surfaces of plastics and/or glass and/or ceramics and/or porcelain and/or quartz and/or granite and/or metal and/or wood, wherein it is particularly preferred that the surfaces to be treated originate from crockery, windows, tiles, floor coverings, wood and stone surfaces and floors and walls as well as coated or uncoated tanks or other containers, lines, conveyor belts, containers, such as for example returnable bottles made from glass, plastics, such as PET, or textiles.

In one particularly preferred embodiment, it may be observed on use of the preparations to be used according to the invention that, over a relatively extended period, it is possible to reduce the wear, susceptibility to scratching and corrosion of plastics.

It is also preferred that the preparations to be used according to the invention are brought into contact with the surfaces to be treated during or after manual or machine dish rinsing and/or washing operations, wherein it is particularly preferred to use the preparations to be used according to the invention as a rinse aid.

The present invention also provides a process for cleaning surfaces, in which in at least one process stage the surfaces are brought into contact with the preparation to be used according to the invention with the effect that the surfaces treated in this manner, once soiled, are easier to clean in a subsequent cleaning operation than surfaces which have not come into contact with these preparations.

It is particularly preferred if this process according to the invention is used for cleaning crockery.

The present invention furthermore provides a soil release preparation which contains, relative to the entire preparation,

a) between 0.2 and 40 wt. % of a foaming surfactant selected from among sodium lauryl sulfate, lauryl glucoside, lauryl ethanolamide, and

b) between 0.1 and 20 wt. % of the calcium compound, particularly preferably calcium chloride or calcium acetate,

as well as a rinse aid which contains such a preparation. The calcium present may here be bound by the surfactants or by another means.

### EXAMPLES

In practical tests, porcelain plates are exposed to a rinse aid during the washing process in a dishwasher. Comparative tests are here conducted to investigate the influence of using rinse aids, which contain bound calcium according to the invention, upon temporary soil release behaviour and foaming behaviour.

Performance of Temporary Soil Release Behaviour Testing:

1. Preparation of the Plates to be Coated

Using a conventional domestic dishwasher (for example from Miele), dinner plates for commercial use of a diameter of 25 cm are completely washed at at least 70° C. with a conventional commercial dishwashing detergent, such as for example Perclin Supra. The plates cleaned in this manner are used for the tests.

2. Preparation of a Single Tank Dishwasher

The tank of a single tank dishwasher (for example from Krefft) is filled with softened water and heated to an operating temperature of 60° C. The cleaning solution is adjusted such that the concentration of Perclin Supra in the tank is 1 g per litre of water.

The feed line for the rinse aid dispenser is connected between the boiler and tank of the dishwasher (single tank dishwasher). The dispenser setting is adjusted such that approx. 0.57 g of rinse aid are apportioned per litre of softened water. The single tank washing machine is adjusted to consume approx. 5 litres of softened water per rinse cycle. The water temperature during the rinse cycle is adjusted to 75° C.

3. Performance of the Test:

For each test, 10 cleaned dinner plates are placed in a rack into the single tank dishwasher prepared as above. The dinner plates stand upright and offset in the rack. The dishwasher is closed and the plates are subjected to a 60 second cleaning stage at 60° C. with an aqueous Perclin Supra solution. The rinse cycle begins immediately after the cleaning stage. The aqueous solution of the rinse aid to be investigated is applied at a temperature of 70° C. onto the dinner plates by means of a sprayer. Once the rinse cycle is complete, the dishwasher is opened and the rack containing the plates taken out. After cooling and drying at room temperature, the dinner plates treated in this manner are soiled with a starchy soil in accordance with a standardised test method. To this end, an approx. 6% aqueous preparation containing maize starch is boiled, cooled to 75° C. and approx. 4 mL is applied onto each plate with a paint brush. The plates treated in this manner are left to stand for at least 3 hours and are then dried for 16 hours at approx. 100° C. After cooling, the plates are further treated as described below.

The cleaning stage in the single tank dishwasher is repeated with the dinner plates which have been treated with the various rinse aids and then soiled. To this end, the tank of the single tank dishwasher is again filled with softened water. 1 g of dishwasher detergent Perclin Supra is added per litre of softened water. The single tank dishwasher is adjusted to an operating temperature of 60° C. The soiled plates are again placed in the dishwasher upright in a rack and the single tank dishwasher is closed. The 60 second cleaning stage is repeated five times such that cleaning is performed for a total of five minutes. The dishwasher is then immediately opened and the rack holding the dinner plates taken out of the dishwasher. The dinner plates dry and cool at room temperature. In order to reveal any remaining starch residues, the dinner plates are briefly dipped into an iodine solution prepared in a standard manner by dissolving iodine and potassium iodide in water.

The revealed remaining starch soiling is rated by means of comparison plates. The rating scale ranges from 0=not clean (no discernible starch removal) to 10=as clean as possible. The results of the investigations are shown in Table 1.

Performance of Foaming Behaviour Tests for the Rinse Aids:

In addition to the soil release behaviour, the foaming behaviour of the rinse aid formulations was also investigated. The following test was used for this purpose:

Foam in Intensive Foaming Apparatus:

The apparatus is filled with approx. 40 L of softened water. In order to make the conditions more severe, approx. 180 g of foaming detergents are added to the water with the circulating pump in operation. At the same time, approx. 10 g of the particular rinse aid 1 to 4 to be investigated are added. While the solution is being circulated, the temperature is raised to 60° C. and the foam height determined by means of a measuring scale.

4. Influence of Various Rinse Aids Upon Temporary Soil Release Behaviour and Upon Foaming Behaviour

As may be seen in Table 1, the rating of the cleaning result is substantially better when the preparation to be used according to the invention is used, than in the case of dinner plates, the treatment of which was performed without an agent containing bound calcium.

Treatment with a preparation which contains sodium lauryl sulfate and calcium chloride thus visibly facilitates the surface cleaning process, as demonstrated by way of example with the dinner plates.

Rinse aids 2 to 4 contain sodium lauryl sulfate, which has a strong tendency to foam. Foaming is intended to be controlled in rinse aid 3 by the addition of a particulate defoamer. The result, however, is that rinse aid 3 is a turbid solution and the formulation tends to segregate. Moreover, there is still a relatively high level of foaming in the intensive foaming apparatus.

Very severe foaming is measured for rinse aid 2. Foaming may be substantially reduced by using rinse aid 4 according to the invention without the formulations being turbid or having a tendency to segregate. Foaming in the intensive foaming apparatus was even comparable with rinse aid 1, which contains no sodium lauryl sulfate.

Rinse aid 1: Initial formulation

Rinse aid 2: Temporary soil release rinse aid without defoamer

Rinse aid 3: Temporary soil release rinse aid with particulate defoamer

Rinse aid 4: Temporary soil release rinse aid with CaCl₂.

TABLE 1
Results from soil release and foaming tests

| | Rinse aid | Rinse aid | Rinse aid | Rinse aid |
|---|---|---|---|---|
| Raw materials | 1 | 2 | 3 | 4 |
| Na lauryl sulfate | 0.00 | 5.00 | 5.00 | 5.00 |
| Fatty alcohol + EO + PO | 21.00 | 21.00 | 21.00 | 21.00 |
| Low-foaming fatty | 8.00 | 3.00 | 3.00 | 3.00 |
| alcohol ethoxylate | | | | |
| Na cumene sulfonate, | 7.00 | 7.00 | 7.00 | 18.00 |
| 40% | | | | |
| Ethanol | 4.00 | 4.00 | 4.00 | 4.00 |
| Particulate defoamer | 0.00 | 0.00 | 2.00 | 0.00 |
| with SiO₂ and paraffin | | | | |
| wax | | | | |
| CaCl₂ | 0.00 | 0.00 | 0.00 | 2.50 |
| Water | 60.00 | 60.00 | 58.00 | 50.50 |
| Appearance | clear, | clear, | turbid, | clear, |
| | stable | stable | segregates | stable |
| Rating of soil release | 3.5 | 6.5 | 6.5 | 8.0 |
| result | | | | |
| Foam in shaking test | 100 ml | 140 ml | 115 ml | 120 ml |
| (60° C.) | (0 ml) | (40 ml) | (15 ml) | (20 ml) |
| Foam in intensive | 210 mm | 270 mm | 250 mm | 210 mm |
| foaming apparatus with | | | | |
| Solid Force | | | | |

1. Use of a stable aqueous preparation, which contains both a foaming surfactant and calcium in bound form, in undiluted or diluted form for treating surfaces, in order to obtain surfaces which may subsequently more easily be cleaned using conventional agents than identical surfaces which have not been treated with the claimed preparations.

2. Use according to claim 1, characterised in that the preparation contains, relative to the entire preparation,
c) between 0.2 and 40 wt. % of the foaming surfactant and
d) between 0.1 and 20 wt. % of a calcium compound, preferably calcium chloride or calcium acetate.

3. Use according to one of claims 1 or 2, characterised in that the preparation contains, as foaming surfactant, one or more components selected from the group consisting of non-alkoxylated surfactants containing alkyl groups with a saturated or unsaturated, branched or linear alkyl group with 8 to 22 C atoms.

4. Use according to claim 3, characterised in that the preparation contains, as non-alkoxylated surfactant containing alkyl groups, one or more components selected from the groups consisting of
a) alkyl sulfates with a saturated or unsaturated, branched or linear alkyl group with 8 to 22 C atoms,
b) alkyl glucosides with a saturated or unsaturated, branched or linear alkyl group with 8 to 22 C atoms,
c) fatty acid ethanolamides with a saturated or unsaturated, branched or linear alkyl group with 8 to 22 C atoms.

5. Use according to claim 4, characterised in that the preparation contains sodium lauryl sulfate from group a).

6. Use according to one of claims 4 or 5, characterised in that the preparation contains lauryl glucoside from group b).

7. Use according to claim 6, characterised in that lauryl glucoside imparts additional antimicrobial protection to the treated surface.

8. Use according to one of claims 4 to 7, characterised in that the preparation contains lauryl ethanolamide from group c).

9. Use according to one of claims 1 to 8, characterised in that the preparation additionally contains one or more further surfactants selected from the groups consisting of anionic, cationic, nonionic, amphoteric surfactants, alkylamine oxides, silicone compounds and phosphoric acid esters and the salts thereof.

10. Use according to claim 9, characterised in that the preparation contains, as further nonionic surfactant, an alkoxylated alkyl alcohol with 8 to 22 C atoms in the alkyl chain.

11. Use according to claim 10, characterised in that the further nonionic surfactant is a non- or low-foaming surfactant selected from the group consisting of mixed ethoxylates/propoxylates of branched or unbranched alkyl alcohols with 12 to 22 C atoms in the alkyl moiety.

12. Use according to claim 11, characterised in that the further nonionic surfactant is a non- or low-foaming surfactant selected from the group consisting of methyl and/or butyl ethers of ethoxylated alkyl alcohols with 12 to 22 C atoms in the alkyl moiety.

13. Use according to one of claims 1 to 12, characterised in that the preparation additionally contains one or more antimicrobial components selected from the group consisting of alcohols, aldehydes, antimicrobial acids, carboxylic acid esters, acid amides, phenols, phenol derivatives, diphenyls, diphenylalkanes, urea derivatives, oxygen/nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophores, peroxides.

14. Use according to one of claims 1 to 13, characterised in that the preparation additionally contains solubilising agents.

15. Use according to one of claims 1 to 14, characterised in that the preparation assumes the form of a stable aqueous solution, gel, paste or shaped solid.

16. Use according to one of claims 1 to 15, characterised in that the surface to be treated is treated with the undiluted or diluted preparation by dipping.

17. Use according to one of claims 1 to 15, characterised in that the surface to be treated is treated with the undiluted or diluted preparation by auxiliary means, which are selected from among paint brushes, sponges, rollers, cloths, rags, brushes, squeegees, rubber, mops, flat mop heads, sprayer.

18. Use according to one of claims 1 to 17, characterised in that the materials of the surface to be treated are selected from among plastics and/or glass and/or ceramics and/or porcelain and/or quartz and/or granite and/or metal and/or wood.

19. Use according to claim 18, characterised in that the surfaces to be treated originate from crockery.

20. Use according to one of claims 1 to 19, characterised in that the preparation is used as a rinse aid in dishwashing.

21. Process for cleaning surfaces in which in at least one process stage the surfaces are brought into contact with one of the preparations to be used according to one of claims 1 to 15.

22. Soil release preparation, characterised in that the preparation contains, relative to the entire preparation,
a) between 0.2 and 40 wt. % of a foaming surfactant selected from among sodium lauryl sulfate, lauryl glucoside, lauryl ethanolamide, and
b) between 0.1 and 20 wt. % of the calcium compound, preferably calcium chloride or calcium acetate.

23. Rinse aid which contains a preparation according to claim 22.
